(19) United States
(12) Patent Application Publication
(10) Pub. No.: US 2009/0199469 A1
(43) Pub. Date: Aug. 13, 2009

(54) IRRIGATION MEANS

(75) Inventor: Ralf WALKER, Nurtingen (DE)

Correspondence Address: BROWDY AND NEIMARK, P.L.L.C.;624 NINTH STREET, NW, SUITE 300, WASHINGTON, DC, 20001-5303, US

(73) Assignee: Zinco Gmbh, Unterensingen (DE)

(21) Appl. No.: 12/030,023

(22) Filed: Feb. 12, 2008

(30) Foreign Application Priority Data
Feb. 12, 2008 (DE) 10 2007 006 766.8

(51) Int. Cl. A01G 27/04

(52) U.S. Cl. 47/48.5

(57) ABSTRACT

A irrigation means from the irrigation of a vegetation substrate by capillary action comprises a flat, sheet-like substrate base able to impart water to the vegetation substrate and able to be supplied with water by way of a capillary irrigation structure and the substrate base and the irrigation structure are united as a uniform irrigation mat able to be handled as a single assembly bodily.

### BACKGROUND OF THE INVENTION

The invention relates to an irrigation means for the capillary irrigation of a vegetation substrate comprising a sheet-like substrate base providing water for the vegetation substrate, and able to be supplied with water by way of a capillary irrigation structure.

### THE PRIOR ART

An irrigation means of the type initially mentioned is disclosed in the German patent publication DE 200 13 218 U1. In this case an absorptive non-woven material is spread out on tables or in troughs. The non-woven material is moistened by way of wicks or strips of non-woven material from an underlying water reservoir. The wicks extend upward at several points with an even spacing between them and are spread out in a radiating manner underneath the non-woven material so that the most even possible moistening of the non-woven material takes place. The wicks must in this case however be separately placed in position prior to laying. Furthermore a sheet-like base underneath the non-woven material must be as flat as possible in order to thrust the wick material, against the non-woven material so that the water conveyed by the wicks by capillary action reliably to the non-woven material.

The German patent publication DE 196 10 241 C2 discloses an irrigation means serving for long term moistening of a root clump of a pot plant. A pot with a vegetation substrate is provided with a plate-like body of porous, hygroscopic manner on the bottom of the pot. A flexible wick is incorporated in the body which protrudes by way of hole in the bottom of the pot into a water reservoir arranged underneath the pot. The wick then draws up water by capillary action and passes it on to the hygroscopic material, which for its part supplies the vegetation substrate with water. The manufacture of the porous, hygroscopic body and the incorporation of the wick are relatively complex operations. Furthermore such a irrigation means is in many cases unsuitable for flat greenings on roofs, since in this case a large number of the bodies are necessary and they must be individually designed.

### SHORT SUMMARY OF THE INVENTION

One object of the invention is to provide an irrigation means of the type initially mentioned able to be economically manufactured, is simple and time saving in use and is suitable for different fields of application.

This object is to be achieved by an irrigation means with the features of the independent claim 1 herein. Further developments of the invention are defined in the dependent claims.

The irrigation means in accordance with the invention is characterized in that the substrate base and the irrigation structure are collected together as a single structural unit to form a irrigation mat which can be bodily handled as a single structure.

The irrigation mat accordingly combines the substrate base and the irrigation structure with the result that simple, rapid and economic laying is possible. The complex process of firstly laying separate wicks or, respectively, the complicated production of a porous, hygroscopic body, which is unsuitable for flat greened areas on buildings and the accompanying complex process of laying the wicks, is not necessary. The irrigation mat in accordance with the invention can be laid in a single operation. It is characterized furthermore by having a relatively low weight and is consequently particularly suitable for greening roofs in the case of which the weight plays an important role owing to the maximum permitted roof load. The irrigation mat can be laid in a horizontal or in an oblique position. Furthermore it is readily possible to use gardening tools such as hoes, rakes or the like without any difficulty.

It is in particular preferred for the irrigation mat to be in the form of strips. It is possible for several such strip-like irrigation mats to be laid juxtaposed so that in a short time a large area may be covered. It is possible for respectively juxtaposed irrigation mats to be laid with an overlap at their longitudinal edges. For this purpose the irrigation mats may in each case be free of irrigation structure at the longitudinal edges.

It is more especially preferred for the irrigation mat to be flexible and in particular able to be rolled up and unrolled. Hence the irrigation mat may be packed in a convenient size for shipping. On site laying like a carpet by unrolling will take place. Alternatively it is however also possible for the irrigation mat to be stiff in structure.

In the case of a further development of the invention the irrigation mat will consist of a material resistant to weathering. This means that the service life of the irrigation mat is increased.

It is possible furthermore for the irrigation mat to consist of a material with a filtering unction as regards the overlying vegetation substrate. Accordingly a separation is possible between the vegetation substrate and a water storage means arranged underneath the irrigation mat. This will avoid any material from the vegetation substrate finding its way into the water storage means.

It is possible furthermore for the irrigation mat to at least partly consist of material which can be recycled.

In a particularly manner the substrate base and the irrigation structure of the irrigation mat consist of the same material. However in principle it would also be possible, even with the substrate base and the irrigation structure designed together as a single structural unit, for the substrate base and the irrigation structure to be manufactured of different materials.

The substrate base may at least in part consist of capillary material. Accordingly transport of water by capillary action within the substrate base is possible.

In the case of a further development of the invention the substrate base is constituted by a non-woven material and/or a foil and/or a fabric and/or a knitted material and/or a grid. Preferably textile material is employed for the substrate base. As a textile material of the looped stitch type a warp or weft knitted fabric is suitable. However non-textile materials may be employed, which can provide the vegetation substrate with water.

It is more particularly preferred for the irrigation structure to be a component of the substrate base. The irrigation structure may consequently for example be formed by the material of the substrate base.

It is more especially preferred for the irrigation structure to be constituted by a plurality of flexible capillary elements arranged above the face of the substrate base and standing proud of it. Preferably the capillary elements are constituted by fibers. However, wicks would also be possible.

In the case of a further development of the invention several irrigation mats are connected, or able to be connected, together by means of connecting means. As connecting means hook and loop fasteners may be employed. However adhesive means as for example adhesive tape or the like may be utilized.

The irrigation means may have a spacer device arranged or able to be arranged underneath the irrigation mat for spacing the substrate base from the surface of water in a reservoir provided for the irrigation structure. This avoids the substrate base from becoming overly saturated and possibly then supplying too much water to the vegetation substrate.

The spacer device may comprise a plurality of spacing elements arranged in a grid. The spacer elements can be designed in a, fashion linked together, neighboring spacer elements being able to be connected together by trough sections serving as a water reservoir. The spacer device may in the alternative also be constituted by separate spacer elements not joined together.

Further advantageous developments and convenient forms of the invention will be understood from the following detailed descriptive disclosure of preferred embodiments thereof in conjunction with the accompanying drawings.

### LIST OF THE SEVERAL VIEWS OF THE FIGURES

FIG. 1 is a side elevation of a irrigation mat, presently in the operational state of the irrigation means of the invention.

FIG. 2 is a side view of the irrigation mat of FIG. 1 in a partially rolled up state.

FIG. 3 represents a section through a greening element as a first embodiment of the irrigation means in accordance with the invention.

FIG. 4 is a section taken through a greening element, a second working example of the irrigation means of the invention being illustrated.

### DETAILED ACCOUNT OF WORKING EMBODIMENTS OF THE INVENTION

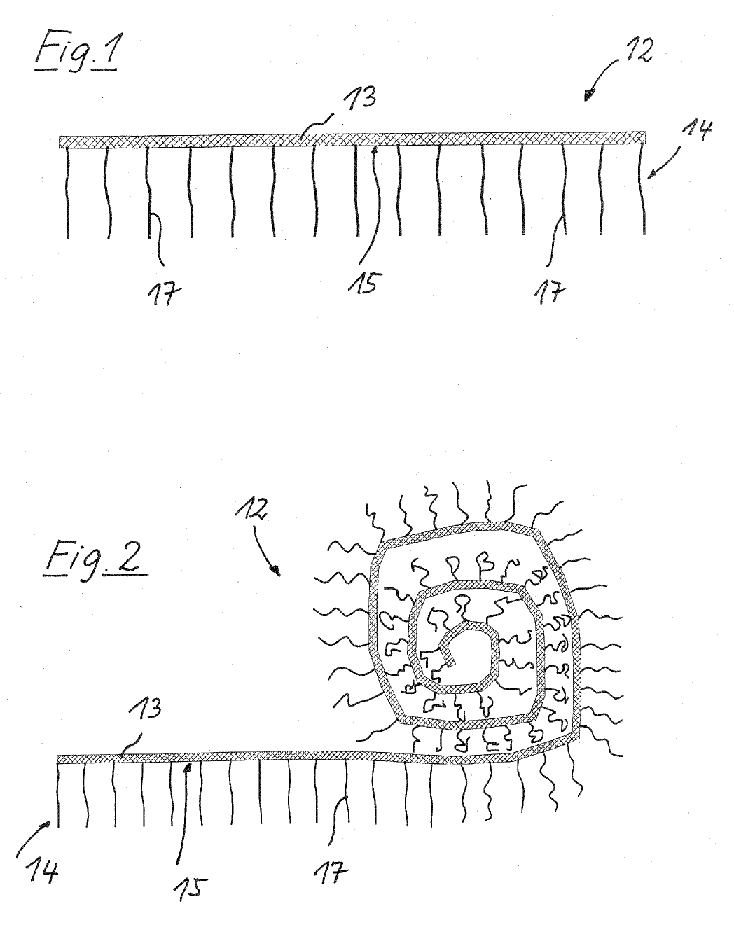

FIGS. 1 and 2 illustrate an important component of the irrigation means 11 in accordance with the invention, namely a flat or sheet-like irrigation mat 12. The irrigation mat 12 consists of a substrate base 13 of sheet-shaped configuration and an irrigation structure 14 which in the position of use arranged on the bottom side of the substrate base 13, which are joined together as a single unit. The substrate base 13 and the Irrigation structure 14 may therefore be moved about bodily.

The substrate base 13 is in the example in the form of a woven fabric consisting of textile fiber or a textile knitted material. The substrate base 13 dispenses water obtained by way of the irrigation structure 14 to a superposed vegetation substrate 16 (FIG. 1, 2 or 3). Preferably the substrate base has a water storage capacity.

The irrigation structure 14 is constituted by a plurality of threads 17 on the bottom side of the substrate base with a distribution over its area. The threads consist of the same textile material as the substrate base 13. The threads 17 are capillary threads so that water may be drawn upward against gravity into the substrate base.

The irrigation mat 12 can, owing to the flexibility of the substrate base 13 and the limp character of the threads 17 applied to it, be simply rolled and unrolled so that sheet and quick laying is possible. For the irrigation of large areas, f. i. for the Irrigation of greened roofs, several irrigation mats 12 are placed adjacent to each case, neighboring mats 12 being disposed so that they overlap at the longitudinal edges. On the longitudinal edges there are no threads 12 so that a connection between the neighboring irrigation mats 12 using suitable connecting means, as for example a fastner with loops and hooks is possible.

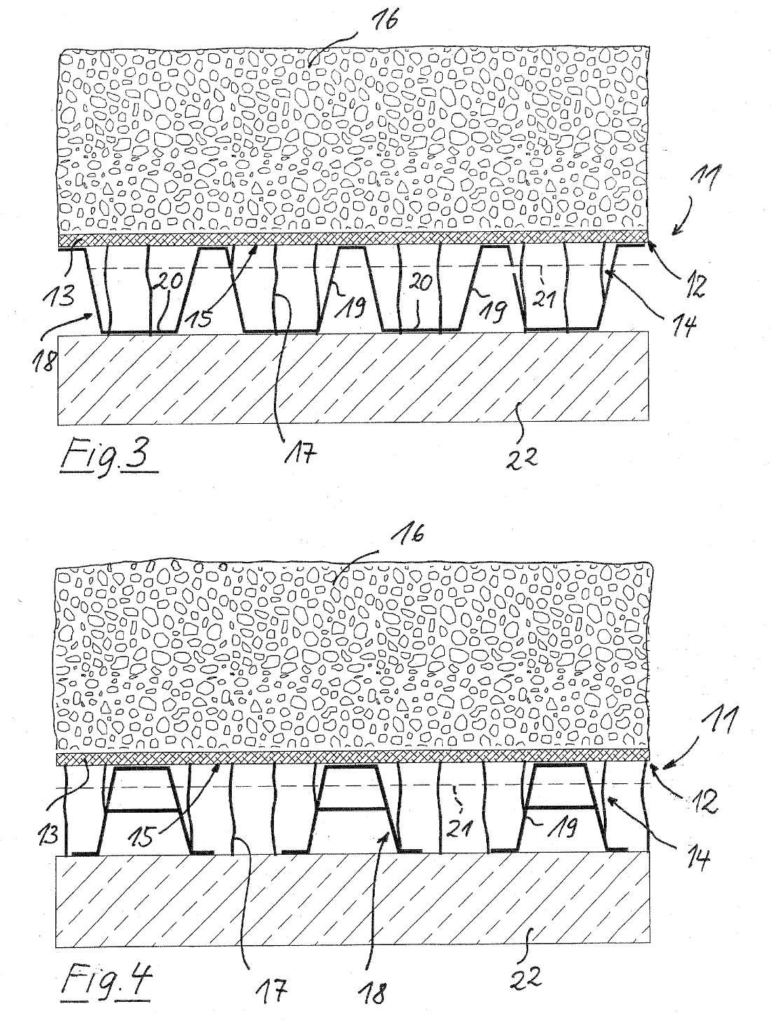

FIG. 3 shows a first working example of the irrigation means 11 of the invention. The vegetation substrate 16 is arranged on top of the irrigation mat 12 as already stated. The textile substrate base 13 here functions as a filter so that the vegetation substrate 16 is prevented from penetrating the irrigation mat 12. Underneath the irrigation mat 12 there is a spacer device 18 made up, in the first working example of the irrigation means 11, of a plurality of spacer elements 19 or extruded elements arranged in a grid, adjacent spacer elements 19 being joined together by trough sections 20 with each other. The spacer device 18 serves to ensure that the substrate base 13 is clear of the water surface in order to avoid overly saturating the substrate base 13. As shown in FIG. 3 therefore only the threads 17 dip into the water. The water level 21 is consequently somewhat underneath the bottom side 15 of the substrate base 13. The spacer device 18, which is characterized by spacer elements 19 joined together with one another, could also be termed a flat irrigation mat. Such a irrigation mat can be flexible so that it can be rolled u and unrolled in a manner similar to the irrigation mat 12 too so that in this case as well laying may be simply and quickly performed. As a material for such a spacer mat a plastic is for example suitable. The spacer mat has other functions besides the spacing function, namely serving as a water storage means for even distribution of the water over the area. As shown in FIG. 3 the water can therefore be held in the trough sections 20 between the spacer elements. In this respect neighboring trough sections can be connected together by an overflow (not illustrated) so that the water levels 21 in the respective trough sections 20 are substantially at the same height. The spacer device 18 or, in accordance with FIG. 3, the spacer mat is again arranged on a base or on a supporting shell 22.

FIG. 4 shows a second working embodiment of the irrigation means 11 in accordance with the invention. It differs from the previously described first embodiment of the invention because the spacer device 18 is made up of a plurality of separate spacer elements 19 or respectively profiles, which are not joined together. Here as well the spacer elements 19 cause the bottom side of the substrate base 13 to be held at a distance from the surface of the water. The water level 21 is hence somewhat spaced from the bottom side 15 of the substrate base 13. Accordingly in this case only the threads 17 dip into the water. The water is however not held in trough sections as in the first working example, and is directly in contact with the impermeable base 22. Here as well draining takes place since water may be distributed over the area, it flowing between the spacer elements 19.

In summary it is to be noted that the irrigation mat 12 of the irrigation means 11 in accordance with the invention is characterized in that the substrate base 13 and the irrigation structure 14 constituted by the threads are united as an assembly which may be bodily handled. The irrigation mat 12 can be rolled up compactly when not in use. Laying may take place in a simple and time saving fashion by unrolling the Irrigation mats 12. The irrigation mat 12 possesses a relatively small overall height and is characterized by a relatively low weight. The length of the threads, their capillary properties and furthermore the distance between the bottom side of the substrate base and the water surface may be so selected that no excess supply to the substrate occurs. Moreover, the installation of the irrigation mats 12 may take place so that in the case of the use of a spacer device 18 in accordance with the first working example it is not possible for all the water to drip off, for example if the irrigation mats 12 are arranged hanging over and past the spacer device.

1. An irrigation means for the capillary irrigation of a vegetation substrate comprising a sheet-like substrate base providing water for the vegetation substrate, and able to be supplied with water by way of a capillary irrigation structure, wherein the substrate base and the irrigation structure are collected together as a single structural unit to form a irrigation mat which can be bodily handled as a single structure.

2. The irrigation means as set forth in claim 1, wherein the irrigation mat is strip-like in form.

3. The irrigation means as set forth in claim 1, wherein the irrigation mat is flexible and is more particularly able to be rolled up and unrolled.

4. The irrigation means as set forth in claim 1, wherein the irrigation mat is manufactured of weathering-resistant material.

5. The irrigation means as set forth in claim 1, wherein the irrigation mat is designed with a filtering function for the superposed vegetation substrate.

6. The irrigation means as set forth in claim 1, wherein the irrigation mat is at least partially composed of material able to be recycled.

7. The irrigation means as set forth in claim 1, wherein the substrate base and the irrigation structure are manufactured of the same material.

8. The irrigation means as set forth in claim 1, wherein the substrate base is at least in part manufactured of a material with capillary properties.

9. The irrigation means as set forth in claim 1, wherein the substrate base is constituted by a material selected from the group including non-woven material, a foil, a fabric, a knitted material, a grid.

10. The irrigation means as set forth in claim 9, wherein the substrate base consists of a textile material.

11. The irrigation means as set forth in claim 1, wherein the irrigation structure is a component of the substrate base.

12. The irrigation means as set forth in claim 1, wherein the Irrigation structure is constituted y a plurality of flexible capillary element distributed over the surface of the substrate base and standing proud of same.

13. The irrigation means as set forth in claim 12, wherein the capillary elements are constituted by threads.

14. The irrigation means as set forth in claim 1, wherein a plurality of irrigation mats are joined together or able to be joined together by means of connecting means.

15. The irrigation means as set forth in claim 14, wherein the connecting means are formed by hook and loop fasteners.

16. The irrigation means as set forth in claim 1, further comprising a spacer device arranged or able to be arranged underneath the irrigation mat for spacing out the substrate base from the water surface in a water reservoir associated with the irrigation structure.

17. The irrigation means as set forth in claim 16, wherein the spacer device comprises a plurality of spacer elements arranged in a grid configuration.

18. The irrigation means as set forth in claim 17, wherein the spacer elements are designed linked together, neighboring spacer elements being joined together by trough sections serving as a water reservoir.
